(19) United States
(12) Patent Application Publication
(10) Pub. No.: US 2011/0163716 A1
(43) Pub. Date: Jul. 7, 2011

(54) Battery Charger Temperature Control System And Method

(75) Inventors: Allan Roy Gale, Livonia, MI (US); Paul Theodore Momcilovich, Tecumseh, MI (US); Michael W. Degner, Novi, MI (US)

(73) Assignee: FORD GLOBAL TECHNOLOGIES, LLC, Dearborn, MI (US)

(21) Appl. No.: 12/938,843

(22) Filed: Nov. 3, 2010

(51) Int. Cl. H02J 7/00

(52) U.S. Cl. 320/109

(57) ABSTRACT

A vehicle includes a traction battery and a battery charger. The battery charger receives electrical energy from an electrical power source if electrically connected with the electrical power source and provides a current to the traction battery at a target value that varies according to a temperature of the battery charger if the temperature falls within a predetermined range of temperatures.

### BACKGROUND

Plug-in hybrid electric vehicles and battery electric vehicles typically include a battery charger that may receive electrical energy from an electrical grid via a wall outlet and provide electrical energy to a traction battery and/or other electrical loads.

### SUMMARY

An automotive vehicle power system may include a battery charger having an input and output. The battery charger may receive electrical energy via the input when the input is electrically connected with an electrical power source. The battery charger may also reduce a current provided at the output from a commanded value to a target value that varies according to a temperature of the battery charger if the temperature falls within a predetermined range of temperatures.

### BRIEF DESCRIPTION OF THE DRAWINGS

FIG. 1 is a block diagram of an automotive vehicle electrically connected with an electrical grid.

FIG. 2 is a flow chart depicting an algorithm for controlling current flow through the battery charger of FIG. 1.

### DETAILED DESCRIPTION

When charging a vehicle from an AC line, there is a desire to ensure that power limits of the charger are not exceeded. Charger components, for example, may heat up when excessive power is being drawn from the AC line, when excessive ambient temperatures occur, and when there is a loss of cooling, etc. A typical approach for limiting the heating of charger components is to terminate the charge when excessive heating occurs. This termination of charging may result in customer dissatisfaction.

Certain battery chargers described herein provide power for charging both a low voltage (LV) vehicle battery and a high voltage (HV) vehicle battery. These chargers may also measure the voltage and current at the output of both the HV and LV systems, and control the HV output current and the LV output voltage set point. This form of low voltage control may result in the LV system supplying smooth regulated output LV voltage for control electronics by supplying all required current to maintain the set point voltage up to the limit of the converter design. While the HV output may have both a smooth voltage and current (hence, power output can be maintained), the LV power output can fluctuate as loads turn on and off in the vehicle.

The general equation relating the input power, P_{acline}, to the charger output power is

$${P}_{acline} = \frac{{V}_{HV} * {I}_{HV}}{{η}_{HV}} + \frac{{V}_{LV} * {I}_{LV}}{{η}_{LV}} \qquad ( 1 )$$

where V_{HV} and V_{HV} are the measured high voltage output voltage and current respectively, V_{LV} and I_{LV} are the measured low voltage output voltage and current respectively, and η_{HV} and η_{LV} are the conversion efficiencies between the AC line and the high voltage output and low voltage output respectively.

The efficiency of conversion varies with power output, input voltage, converter temperature, internal charger component power draw and other factors. This efficiency represents losses in the charging system resulting in thermal dissipation within the charger (and a corresponding temperature rise above ambient). These losses have fixed components such as the power required to run the logic, linear components that vary primarily with the amount of power processed by the charger electronics, and second order losses primarily due to losses in the wiring and other conductive elements. These losses can be approximated as

Chr gr_{Loss}≈K₂*Iₒᵤₜ²R+K₁*Vₒᵤₜ*Iₒᵤₜ+K₀ (2)

where the constants K₀, K₁ and K₂ relate the temperature rise to those components of power loss described above.

Typically in converters containing a magnetic path for isolation of the AC line from the DC side, a significant portion of the losses at high power levels is due to the resistive component, R. Considering (2), a reduction in output current by half will reduce the resistive loss component by a factor of four.

Hence, a step in controlling charger temperature may be to reduce the LV charge rate to a low level (e.g., 13.2 V). While this change may result in an immediate reduction in the charger loss, the slow response of the heat sink mass will slow any temperature decrease in the heat sink, thus avoiding rapid resumption of the LV charge rate. The heat sink temperature can be further controlled by varying the I_{HV} output proportional to the temperature rise, again resulting in a stable control of temperature.

This control scheme may offer an additional advantage because high temperature conditions often occur during high rate charging where Iₒᵤₜ is near the charger rated maximum. The second order term in (2) will dominate the control resulting in stable operation of the charger with only slightly reduced output current.

Thus, a control equation (assuming the LV charge rate has been reduced) can be rewritten as

$${I}_{HVout ( thermal )} = {I}_{{max}_{HV}} * \frac{{T}_{max} - {T}_{charger}}{{T}_{max} - {T}_{min}} \qquad ( 3 )$$

where I_{maxHV} is the maximum design output current of the charger, Tₘₐₓ is the desired temperature for the charger at which to reduce its output to zero (e.g., 60° C.), T_{charger} is the charger temperature, and Tₘᵢₙ is the desired temperature for the charger at which to first begin reducing its output (e.g., 55° C.).

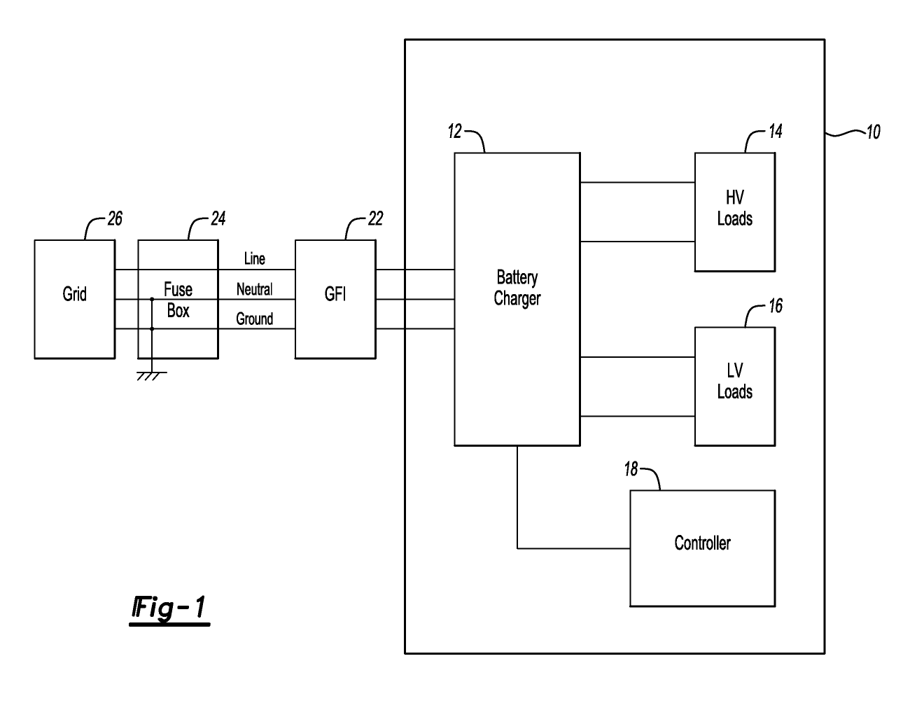

Referring to FIG. 1, a vehicle 10 (e.g., battery electric vehicle, plug-in hybrid electric vehicle, etc.) includes, a battery charger 12, high voltage loads 14 (e.g., traction battery, electric machine, etc.) and low voltage loads 16 (e.g., auxiliary battery, logic circuitry, etc.) The battery charger 12 is electrically connected with the high voltage loads 14 and low voltage loads 16. The vehicle 10 also includes a controller 18. The battery charger 12 is in communication with/under the control of the controller 18. Other arrangements including a different number of loads, chargers, controllers, etc. are also possible.

The battery charger 12 is configured to receive electrical power from an electrical grid (or other power source) 26. For example, the vehicle 10 may be plugged into a wall outlet such that the battery charger 12 is electrically connected with the electrical grid 26 via, in this example, a ground fault interrupter (GFI) 22 (or similar device) and fuse box 24. Line, neutral and ground wires are shown, in this example, electrically connecting the battery charger 12 and grid 26. The ground wire is electrically connected to a chassis (not shown) within the vehicle 10. The ground wire is also electrically connected with the neutral wire and ground at the fuse box 24. Other electrical configurations, such as a 240 V arrangement with L1, L2 and ground wires, are of course also possible.

The controller 18 may command that electrical energy be provided to either/both of the loads 14, 16. For example, the controller 18 may command the battery charger 12 to provide a specified charge current to the traction battery 14 and/or a specified charge voltage to the auxiliary battery 16. Hence in the embodiment of FIG. 1, the battery charger 12 controls the high voltage output current and low voltage output voltage set point. The battery charger 12, in other embodiments, may control high voltage output current and/or voltage set point and low voltage output current and/or voltage set point as desired.

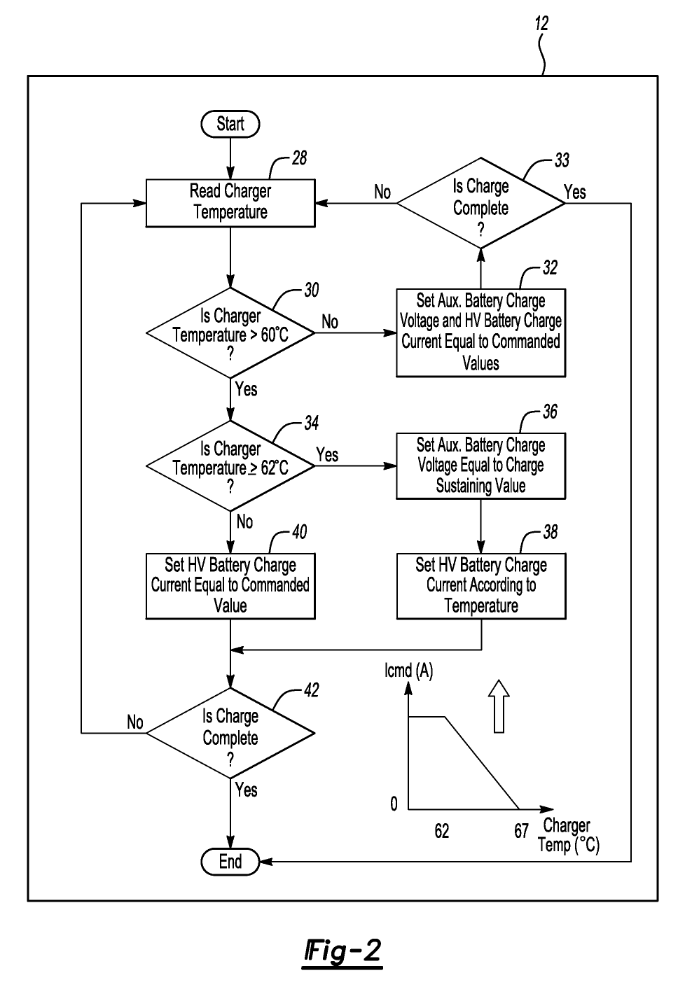

Referring to FIG. 2, the charger temperature is read at operation 28. For example, the battery charger 12 may measure its temperature in any suitable/known fashion. At operation 30, it is determined whether the charger temperature is greater than 60° C. The battery charger 12, for example, may compare the measured charger temperature with a stored value of 60° C. to determine which is greater. If no, the auxiliary battery charge voltage and high voltage battery charge current are set to their commanded values at operation 32. The battery charger 12, for example, may set the current output to the high voltage loads 14 to the value commanded by the controller 18, and set the voltage output set point to the low voltage loads 16 to the value commanded by the controller 18. At operation 33, it is determined whether the battery charge is complete. For example, the battery charger 12 may determine whether its actual state of charge is equal to its target state of charge in any suitable/known fashion. If yes, the algorithm ends. If no, the algorithm returns to operation 28.

Returning to operation 30, if yes, it is determined whether the charger temperature is greater than or equal to 62° C. at operation 34. If yes, the auxiliary battery charge voltage is set to a charge sustaining value at operation 36. The battery charger 12, for example, may set the voltage output set point to the low voltage loads 16 to 13.2 V (or some other charge sustaining value). At operation 38, the high voltage battery charge current is set according to the charger temperature. For example, the battery charger 12 may set the current output to the high voltage loads 14 to zero if the charger temperature is 67° C. or more, and based on the charger temperature if the charger temperature is less than 67° C. and greater than or equal to 62° C. according to the following relations:

$${i}_{HV} = {i}_{cmd} , \\ for {T}_{charger} < {T}_{lwrlim} ;$$

$${i}_{HV} = {i}_{cmd} * \frac{{T}_{lwrlim} - {T}_{charger}}{{T}_{lwrlim} - {T}_{uplim}} , \\ for {T}_{lwrlim} \leq {T}_{charger} < {T}_{uplim} ;$$

$$and , \\ {i}_{HV} = 0 , \\ for {T}_{charger} \geq {T}_{uplim}$$

where i_{HV} is the high voltage output current, T_{charger} is the charger temperature, Tᵤₚₗᵢₘ is, in this example, 67° C., i_{cmd} is the commanded high voltage output current, and T_{lwrlim} is, in this example, 62° C. Other temperature thresholds may also be used. At operation 42, it is determined whether the battery charge is complete. For example, the battery charger 12 may determine whether its actual state of charge is equal to its target state of charge in any suitable/known fashion. If yes, the algorithm ends. If no, the algorithm returns to operation 28.

Returning to operation 34, if no, the high voltage battery charge current is set equal to the commanded value. For example, the battery charger 12 may set the current output to the high voltage loads 14 equal to the value commanded by the controller 18. The algorithm then proceeds to operation 42.

The algorithms disclosed herein may be deliverable to/implemented by a processing device, such as the battery charger 12 or controller 18, which may include any existing electronic control unit or dedicated electronic control unit, in many forms including, but not limited to, information permanently stored on non-writable storage media such as ROM devices and information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

1. An automotive vehicle power system comprising:
a battery charger having an input and output, and configured to (i) receive electrical energy via the input when the input is electrically connected with an electrical power source and (ii) reduce a current provided at the output from a commanded value to a target value that varies according to a temperature of the battery charger if the temperature falls within a predetermined range of temperatures.

2. The system of claim 1 wherein the battery charger further has a second output and is further configured to reduce a voltage set point of the second output from a commanded value to a target value if the temperature falls within the predetermined range of temperatures.

3. The system of claim 2 further comprising an auxiliary battery electrically connected with the battery charger via the second output.

4. The system of claim 1 further comprising a traction battery electrically connected with the battery charger via the output.

5. The system of claim 1 wherein the battery charger is further configured to reduce the current provided at the output from the commanded value or target value to zero if the temperature exceeds the predetermined range of temperatures.

6. The system of claim 5 wherein the battery charger is further configured to increase the current provided at the output from zero to the target value if the temperature subsequently falls within the predetermined range of temperatures.

7. The system of claim 5 wherein the battery charger is further configured to increase the current provided at the output from zero to the commanded value if the temperature subsequently falls below the predetermined range of temperatures.

8. A plug-in hybrid electric vehicle comprising:
an electric machine;
a traction battery electrically connected with the electric machine; and
a battery charger configured to receive electrical energy from an electrical power source if electrically connected with the electrical power source and to provide a current to the traction battery at a target value that varies according to a temperature of the battery charger if the temperature falls within a predetermined range of temperatures.

9. The vehicle of claim 8 further comprising an auxiliary battery, wherein the battery charger is further configured to reduce a voltage set point of the auxiliary battery from a commanded value to a target value if the temperature falls within the predetermined range of temperatures.

10. The vehicle of claim 8 wherein the battery charger is further configured to reduce the current provided to the traction battery to zero if the temperature exceeds the predetermined range of temperatures.

11. The vehicle of claim 10 wherein the battery charger is further configured to increase the current provided to the traction battery from zero to the target value if the temperature subsequently falls within the predetermined range of temperatures.

12. The vehicle of claim 10 wherein the battery charger is further configured to increase the current provided to the traction battery from zero to a commanded value if the temperature falls below the predetermined range of temperatures.

13. A method of charging a vehicle battery comprising:
determining a temperature of a battery charger electrically connected with an electrical power source;
determining whether the temperature falls within a predetermined range of temperatures; and
outputting a current to a vehicle traction battery at a target value that varies according to the temperature if the temperature falls within the predetermined range of temperatures.

14. The method of claim 13 further comprising outputting the current to the vehicle traction battery at a commanded value if the temperature falls below the predetermined range of temperatures.

15. The method of claim 14 further comprising reducing the current output to zero if the temperature exceeds the predetermined range of temperatures.

16. The method of claim 15 further comprising increasing the current output to the target value if the temperature subsequently falls within the predetermined range of temperatures.

17. The method of claim 15 further comprising increasing the current output to the commanded value if the temperature subsequently falls below the predetermined range of temperatures.

18. The method of claim 13 further comprising reducing a voltage set point output to a vehicle auxiliary battery from a commanded value to a target value if the temperature falls within the predetermined range of temperatures.
